(19) United States
(12) Patent Application Publication
(10) Pub. No.: US 2009/0048919 A1
(43) Pub. Date: Feb. 19, 2009

(54) FLEXIBLE ONLINE TRAVEL REWARD DUAL MODEL

(76) Inventor: Michael A. Daly, Avondale, PA (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(21) Appl. No.: 11/839,733

(22) Filed: Aug. 16, 2007

(51) Int. Cl. G06Q 30/00; G06Q 20/00

(52) U.S. Cl. 705/14; 705/27

(57) ABSTRACT

An online travel reward exchange that in response to receipt of search criteria related to a desired travel product provides a first option for a travel product at a lowest available published price (LAPP) related to at least one desired travel product, and provides a second option to see more travel product options related to the at least one desired travel product.

### BACKGROUND

The present invention is related to online travel rewards systems, and more specifically to a flexible online travel reward dual model system.

Many travel rewards programs award customers rewards points for their use of travel products. For example, a customer who uses a travel awards program to book an airline flight, reserve a hotel room, reserve a rental car, book a cruise, etc., may be given a certain amount of travel rewards points for each use that may be redeemed at a later time by the customer to reduce the cost of future reservations for the use of travel products. Fixed ticket pricing models within current travel awards programs are inflexible to the needs of the traveler that needs to travel at certain times or with other non-redeeming family members. Less travel resources (e.g., planes in the air) and increased bookings in the industry often makes it a challenge for customers to redeem earned reward points for the travel itinerary they want under current travel guidelines. Redemption reservations many times require at least twenty one days advance notice and may require a Saturday night stay. Further, air round trip ticketing in many programs must be made through the associated redemption center on the same U.S. carrier, approved by the Airline Reporting Corporation (ARC) that handles airline ticket distribution, control and settlement and controls accreditation of travel agencies that issue airline tickets. Unless redeeming earned reward points for first-class or business-class travel, the ticket may be coach-class and the Lowest Available Published Fare through the travel provider at the time of booking. Customers do not have flexibility of redeeming earned reward points for travel products that may be best for them, for example, other non-Lowest Available Published Fare tickets

### SUMMARY

According to one aspect of the present invention a method for an online travel reward exchange includes: providing a first option for a travel product at a lowest available published price (LAPP) related to at least one desired travel product; and providing a second option to see more travel product options related to the at least one desired travel product.

According to another aspect of the present invention a system for online travel rewards includes: a network interface, the network interface operatively connected to the Internet for receiving criteria for at least one desired travel product; and a processing device, the processing device providing a first option for a travel product at a lowest available published price (LAPP) related to at least one desired travel product, and providing a second option to see more travel product options related to the at least one desired travel product.

According to a further aspect the present invention includes an apparatus comprising a storage medium with instructions stored therein, the instructions when executed causing a processing device to perform: providing a first option for a travel product at a lowest available published price (LAPP) related to at least one desired travel product; and providing a second option to see more travel product options related to the at least one desired travel product.

### BRIEF DESCRIPTION OF THE DRAWINGS

FIGS. 1A-F are examples of resultant travel product costs determination to a user according to example embodiments of the present invention;

FIG. 2 is a flowchart of a process for LAPP in an online travel rewards exchange according to an example embodiment of the present invention;

FIG. 3 is a flowchart of a process for flexible options in an online travel rewards exchange according to an example embodiment of the present invention;

FIG. 4 is a flowchart of a process for travel product cost determination in an online travel rewards exchange according to an example embodiment of the present invention; and

FIG. 5 is a diagram of a system for online travel rewards exchange according to an example embodiment of the present invention.

### DETAILED DESCRIPTION OF THE INVENTION

The following detailed description of embodiments refers to the accompanying drawings, which illustrate specific embodiments of the invention. Other embodiments having different structures and operation do not depart from the scope of the present invention.

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention relate to an Online Rewards Exchange system that allows customers/users redeeming travel awards points flexibility in choosing available travel products. To illustrate the present invention, the terms “customer” and “user” may be used interchangeably for a person who is using the exchange system. The travel awards points may be redeemed for any type or combination of travel products such as, for example, travel products related to airlines, vehicle rentals, hotels, cruises, tours, etc. Further, according to embodiments of the present invention, travel rewards points may be redeemed in combination with a cash payment. For example, if a customer or user desires to use their travel rewards points for a certain travel product or travel product package (i.e., multiple travel products combined for a single cost) that costs more than the value of the travel rewards points that the customer has, the customer may make up this difference in cash. Thus, customers have increased flexibility in choosing available travel products. To illustrate the present invention, embodiments will be discussed related to a travel product that is airline tickets. However, embodiments of the present invention are not limited by these embodiments, but covers any and all types of travel products desired by customers.

In embodiments according to the present invention, an online rewards system combines both the Fixed Ticket Pricing model with a fully variable model to offer customers flexibility in choosing a travel itinerary based on a best value or best flexibility. In embodiments according to the present invention, a customer redeeming rewards points may be shown a Lowest Available Published Fare in the Fixed Ticket Pricing model, and then if that itinerary does not work for them, they may view more itinerary options under a variable model at various point amounts. In embodiments according to the present invention, a customer that is redeeming rewards points for a travel product that has specific requirements, e.g., advance notice in more that a specific number of days, weekend or other stay over requirements, etc., may be immediately directed to a variable model at various point amounts. Therefore, a customer may still have travel product options even though their request does not meet one or more specific terms normally required for the travel product requested.

In embodiments according to the present invention, initially a customer's travel rewards search may result with one option for the Lowest Available Published Fare in the market, with a corresponding Maximum Dollar Value for a specific destination. If the customer does not want the Lowest Available Published Fare, they may click an option to “See more flights or itineraries” and be directed a variable model within the Online Rewards Exchange system. Moreover, in some embodiments, a variable model may be shown initially, and then if none of those options work for the customer, the customer may be allowed to choose the Lowest Available Published Fare in the market, with a corresponding Maximum Dollar Value for a specific destination. A search for one or more travel products or travel packages based on search criteria entered by a client may result in a list of travel products displayed in a user friendly grid that includes associated required points or points plus cash totals in accordance with a defined points exchange criteria.

Embodiments according to the present invention may support multiple pricing exchange methods for travel products. For example, point totals for a travel product may be based on a flat exchange rate, e.g., $0.01-1 point required. Moreover, a multi-tier structure may be used where depending on what price range a cost for a travel product falls into, an associated cash-to-point conversion factor may be used to determine a required point total for the travel product based on the cost of the travel product. Further, travel products whose cost fall below a defined minimum price may be assigned a default minimum point total, (e.g., $0-$199.99=15000 points). In the reverse, a point-to-cash conversion factor may be used to convert points into a cash amount. This may be used when the user does not have enough points to purchase the travel product and must supplement this deficiency with a cash payment.

Table 1 shows a multi-tier conversion structure according to an example embodiment of the present invention. The number of tiers and the specific ranges and conversion factors are for illustrative purposes only and do not limit the scope of the present invention.

TABLE 1

| | | | Associated Basis |
|---|---|---|---|
| Travel Product Cost Range | | Conversion Factor | Points |
| $0.00 | $119.99 | 15,000 points | Minimum |
| $120.00 | $159.99 | 0.0080 | 80 bp |
| $160.00 | $199.99 | 0.0085 | 85 bp |
| $200.00 | $224.99 | 0.0090 | 90 bp |
| $225.00 | $249.99 | 0.0095 | 95 bp |
| $250.00 | $314.99 | 0.0100 | 100 bp |
| $315.00 | $399.99 | 0.0105 | 105 bp |
| $400.00 | + | 0.0105 | 105 bp |

| | |
|---|---|
| Point-to-Cash Conversion Factor | 0.0125 |
| Minimum Redemption Amount | 15,000 |
| Rounding Used | 1 |

According to embodiments of the present invention, the system may determine a point cost of customer request (itinerary). In the event that the requested itinerary point cost exceeds the customer's balance, the system may present to the customer a cash cost to make up the shortfall. The user may establish the point to cash exchange rate. Further, the cash exchange rate may be independent of all other point exchanges. In exchange reward travel embodiments according to the present invention, no qualification rules apply. The system may allow users to redeem travel points for a travel product with short notice, without any weekend requirements, any for class of service, if applicable. Once completed, an itinerary associated with the travel product accepted by the user may be sent to the user by any of many various ways, for example, email, mail, fax, etc.

Moreover, according to embodiments of the present invention, a user may receive a credit for any cash shortfall for a desired travel product. For example, if the user selects a travel product with a cost of $400 which is priced in points at 40,000 points and the customer only has 20,000 points, the shortfall of 20,000 pts may be costed to the user at the shortfall rate (e.g., 110 bp=$220), then the amount billable to the user will be $400−$220=$180. The user cost is $180 or 90 bp.

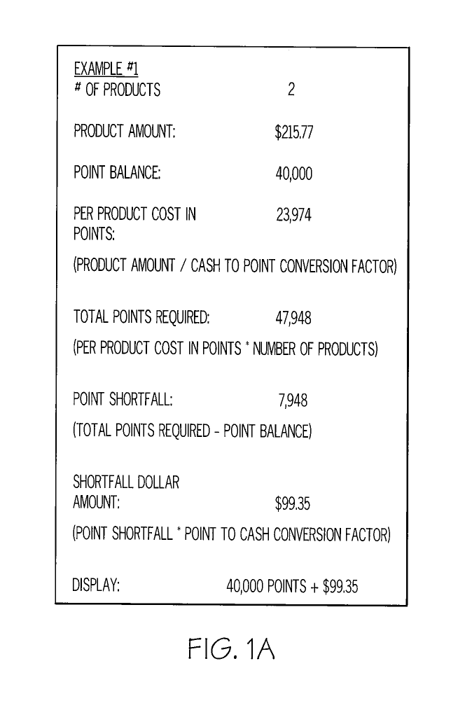

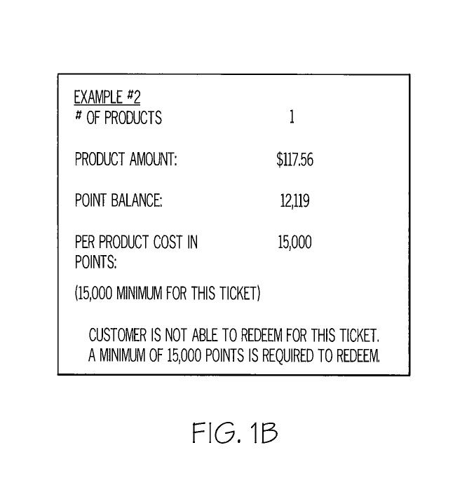

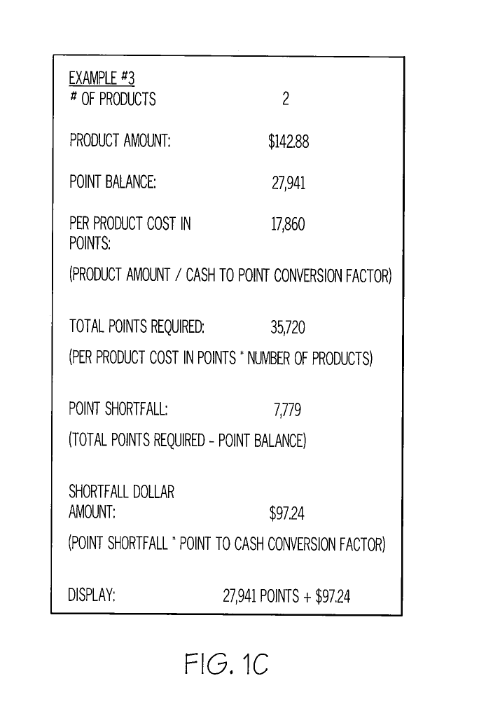

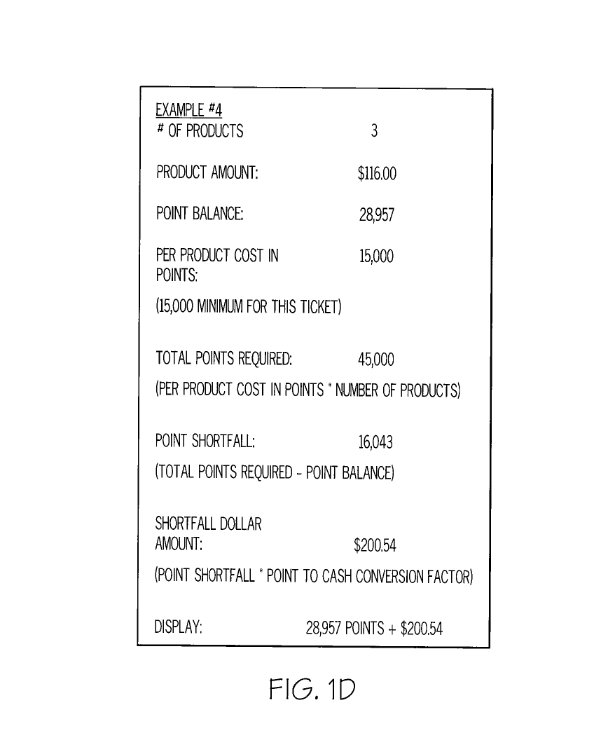

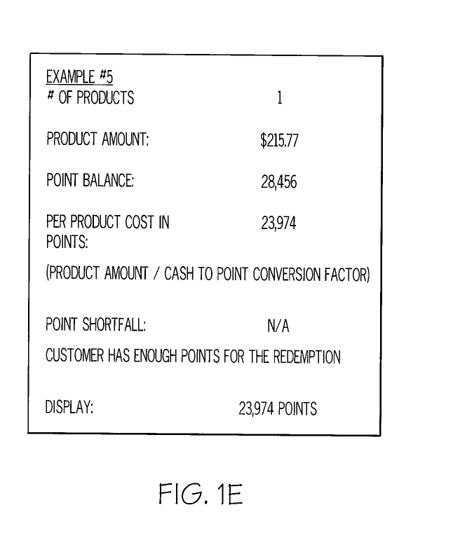

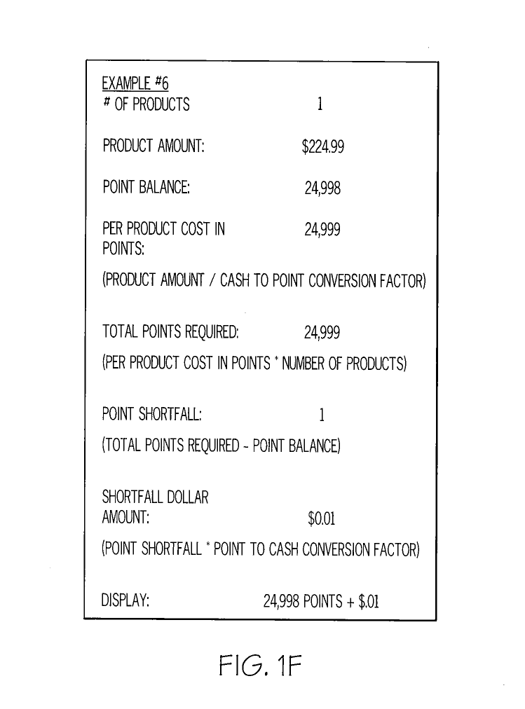

FIGS. 1A-F show examples of resultant travel product costs determination to a user according to example embodiments of the present invention. Referring to Example 1 in FIG. 1A, a user desires to purchase a particular travel product that has a per product dollar value of $215.77. For example if the travel product is an airline ticket, the price of each ticket may be $215.77. Or in another example, if the travel product is a stay at a hotel, the price for each night may be $215.77 (or alternatively $215.77 may be the cost for all nights if the travel product is a package product). The user may have a point balance of 40,000 points that may be used in exchange for the purchase of a travel product. The user desires two travel products (i.e., airline tickets). Initially, the cost of the travel product may be converted to a points total by dividing the travel product amount by a cash-to-point conversion factor (see Table 1 above). The cost of the travel product is looked up in Table 1 and falls into the $200-$224.99 range. Thus, the associated cash-to-point conversion factor for this range is 0.009. The cost of the travel product is divided by this conversion factor to yield a per travel product point equivalent of 23,974 points. Since the user desires two travel products, this point total is multiplied by two resulting in 47,948 total points required to purchase two of these travel products. Since the user only has a point total of 40,000 points, there is a shortfall of 7,948 points. According to embodiments of the present invention, this point shortfall is converted to a dollar amount by multiplying the point shortfall by a point-to-cash conversion factor. As shown in Table 1, the exemplary point-to-cash conversion factor is 0.0125. Thus, the conversion results in a dollar shortfall of $99.35. Therefore, the user is shown on a display that to purchased two of these travel products will require the user's 40,000 points+$99.35. The user then simply needs to cash in his points and pay the cash amount to purchase the travel product.

FIGS. 1B-F show other example scenarios. For example in FIG. 1B, the user may not be able to purchase the desired travel product since the user does not have the minimum number or travel points that may be required for redemption, as defined in Table 1 (15,000 in this example embodiment). In other example embodiments of the present invention, there may be no minimum point total required for redemption towards a travel product thus a user may redeem whatever points he has no matter how low an amount. Further, as shown in FIG. 1E, the user may have more than enough travel points and may be able to purchase a desired travel product with no additional cash required and also still have points left over.

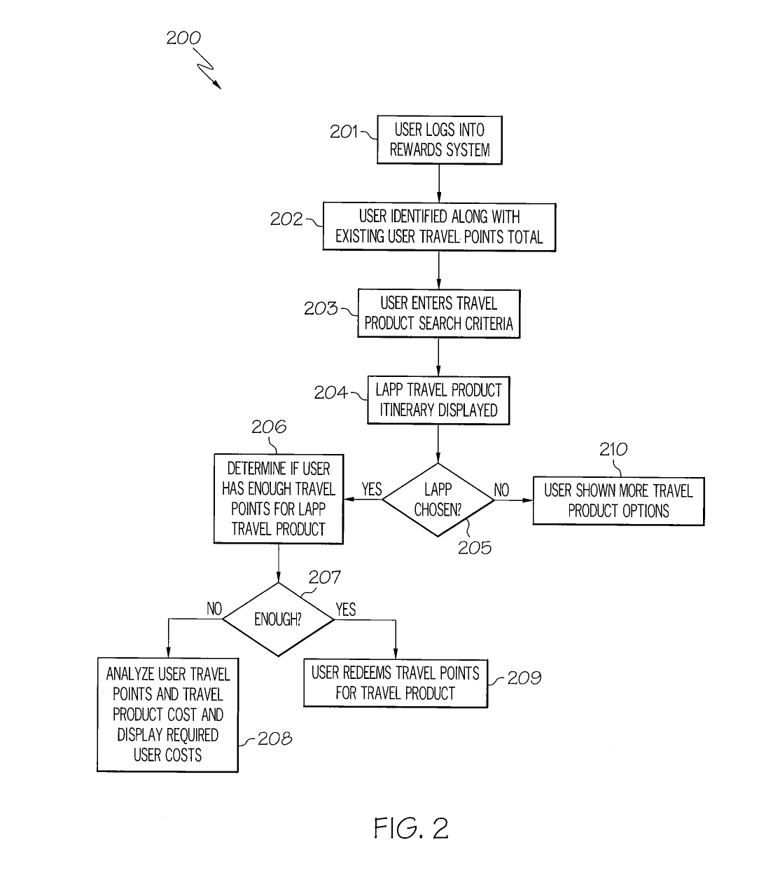

FIG. 2 shows a flowchart of a process for LAPP in an online travel rewards exchange according to an example embodiment of the present invention. In the process 200, in block 201, a user logs into rewards system. In block 202, once the user has logged in, the user may be identified along with existing travel points owned by the user. In block 203, the user may enter travel product search criteria for a desired travel product. In block 204, a lowest available published price (LAPP) travel product itinerary may be identified and displayed to the user in response to the search criteria. In block 205, it may be determined of the LAPP is chosen by the user, and if so, in block 206, it may be determined if the user has enough travel points to exchange for the LAPP travel product. In block 207, if the user does not have enough travel points then in block 208, the user travel points and travel product cost may be compared and analyzed and a required user cost displayed to the user. In block 207, if the user does have enough travel points then in block 209, the user may redeem the travel points for the travel product. If in block 205, the user refuses the LAPP, then in block 210, the user may be shown more travel product options based on the search criteria.

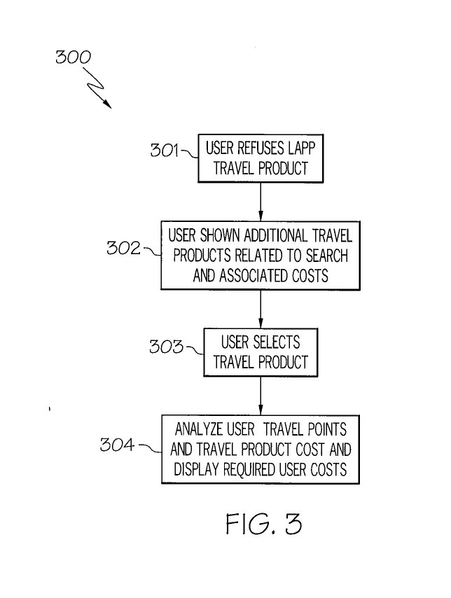

FIG. 3 shows a flowchart of a process for flexible options in an online travel rewards exchange according to an example embodiment of the present invention. In the process 300, in block 301, the user may have refused the LAPP travel product. In block 302, the user may be shown additional travel products related to the search and the associated costs. In block 303, the user may select one of the additional travel products. In block 404, the user travel points and travel product cost may be compared and analyzed and a required user cost displayed to the user.

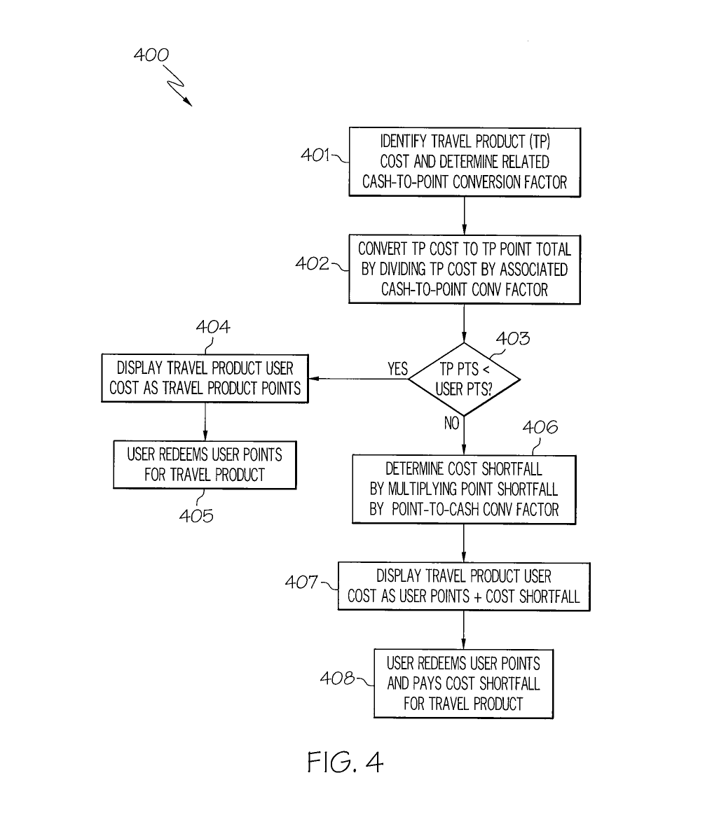

FIG. 4 shows a flowchart of a process for travel product cost determination in an online travel rewards exchange according to an example embodiment of the present invention. In the process 400, in block 401, a travel product (TP) cost may be identified and a related cash-to-point conversion factor determined. In block 401, the TP cost may be converted to TP point total by dividing the TP cost by an associated cash-to-point conversion factor. In block 401, it may be determined if the TP points are less than or equal to the user points, and if so, in block 401, a travel product user cost may be displayed as travel product points. Then, in block 401, the user may redeem the user's points for the travel product. In block 401, if the TP points are more than the user points, then in block 401, a cost shortfall may be determined by multiplying the point shortfall by a point-to-cash conversion factor. In block 401, a travel product user cost may be displayed to the user as user points plus a cost shortfall. In block 401, the user may redeem the user's points and pay the cost shortfall for the travel product.

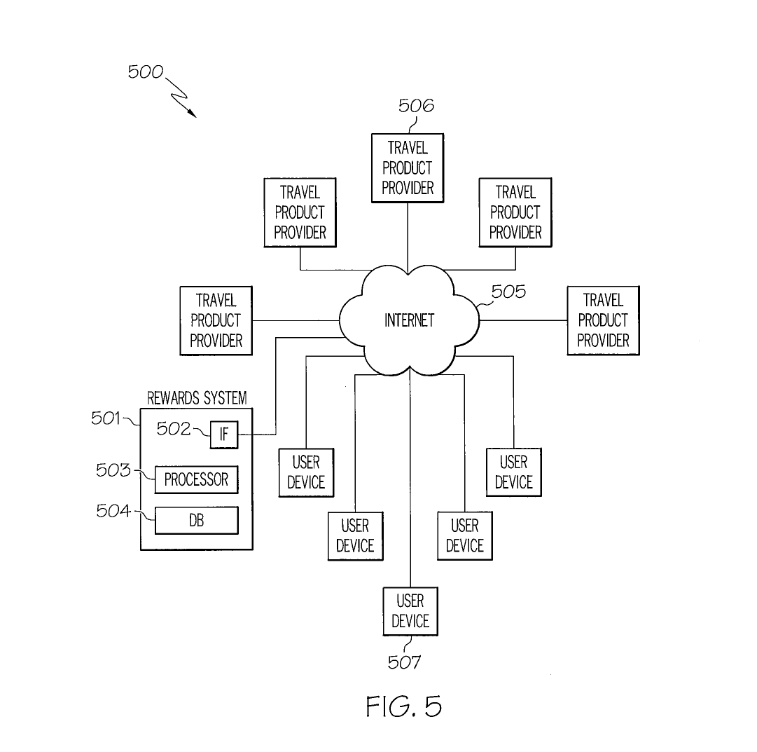

FIG. 5 shows a diagram of a system for online travel rewards exchange according to an example embodiment of the present invention. The system 500 may include a rewards exchange system 501 that may include a network interface 502 for communication with a network 505 such as the Internet and one or more user devices 507, a processor 503, and a database 504. The rewards exchange system 501 may be accessed by one or more user devices 507 over the network 505. The user devices 507 allow a user to access the rewards exchange system 501 to redeem travel points earned for one or more desired travel products. The rewards exchange system 501 may interface with one or more travel product providers 506 to determine available travel products and associated costs. The database 504 may store user information such as name, address, password, etc., as well as a travel point total that the user has accumulated and that are redeemable. The processor 503 may perform all types of processing including processing received search criteria from users, processing information obtained from the travel product providers 506, analyzing travel product cost and user redeemable travel points, and determining a required cost for a travel product for a user in points and/or cash.

A user may use the user device 507 to access the rewards exchange system 501 to enter search criteria for at least one desired travel product. The desired travel products may include any type of travel product such as, for example, a flight, a rental car, lodging, a cruise, a tour, etc. In response, a search result may be obtained and the processor 503 of the rewards exchange system 501 may provide a first option for a travel product at a lowest available published price (LAPP) related to at least one desired travel product to the user, and provide a second option to see more travel product options related to the at least one desired travel product to the user.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method for an online travel reward exchange comprising:
providing a first option for a travel product at a lowest available published price (LAPP) related to at least one desired travel product; and
providing a second option to see more travel product options related to the at least one desired travel product.

2. The method according to claim 1, the at least one desired travel product comprises at least one of a flight, a rental car, lodging, a cruise, or a tour.

3. The method according to claim 1, further comprising providing the first option for a travel product at the lowest available published price to a user in response to a search by the user for the desired at least one travel product.

4. The method according to claim 3, further comprising selecting the travel product at the LAPP by the user and paying for the selected travel product by redeeming travel points earned from the purchase of at least one travel product by the user in the past.

5. The method according to claim 4, further comprising determining a cash-to-point conversion factor based on a cash value of the selected travel product.

6. The method according to claim 5, further comprising determining a point value for the selected travel product based on the cash value of the travel product and the cash-to-point conversion factor.

7. The method according to claim 6, further comprising determining a point shortfall based on a difference between the point value for the selected travel product and a user travel points total.

8. The method according to claim 7, further comprising paying for the selected travel product by redeeming the user travel points and paying a cash amount that equates to the point shortfall.

9. The method according to claim 8, further comprising determining the cash amount by using the point shortfall and a point-to-cash conversion factor.

10. The method according to claim 1, further comprising displaying the more travel product options, each more travel option being different and having an associated cost.

11. A system for online travel rewards comprising:
a network interface, the network interface operatively connected to the Internet for receiving criteria for at least one desired travel product; and
a processing device, the processing device providing a first option for a travel product at a lowest available published price (LAPP) related to at least one desired travel product, and providing a second option to see more travel product options related to the at least one desired travel product.

12. The system according to claim 11, further comprising a database, the database storing information of a user and an accumulated travel points of the user.

13. The system according to claim 11, wherein the network interface provides at least one user device access to the system for sending the criteria for the at least one desired travel product and receiving the first option for a travel product at the lowest available published price (LAPP) and the second option to see more travel product options related to the at least one desired travel product.

14. An apparatus comprising a storage medium with instructions stored therein, the instructions when executed causing a processing device to perform:
providing a first option for a travel product at a lowest available published price (LAPP) related to at least one desired travel product; and
providing a second option to see more travel product options related to the at least one desired travel product.

15. The apparatus according to claim 14, wherein the at least one desired travel product comprises at least one of a flight, a rental car, lodging, a cruise, or a tour.

16. The apparatus according to claim 14, further comprising performing providing the first option for a travel product at the lowest available published price to a user in response to a search by the user for the desired at least one travel product.

17. The apparatus according to claim 16, further comprising performing selecting the travel product at the LAPP by the user and paying for the selected travel product by redeeming travel points earned from the purchase of at least one travel product by the user in the past.

18. The apparatus according to claim 17, further comprising performing determining a cash-to-point conversion factor based on a cash value of the selected travel product.

19. The apparatus according to claim 18, further comprising performing determining a point value for the selected travel product based on the cash value of the travel product and the cash-to-point conversion factor.

20. The apparatus according to claim 19, further comprising performing determining a point shortfall based on a difference between the point value for the selected travel product and a user travel points total.

21. The apparatus according to claim 20, further comprising performing paying for the selected travel product by redeeming the user travel points and paying a cash amount that equates to the point shortfall.

22. The apparatus according to claim 21, further comprising performing determining the cash amount by using the point shortfall and a point-to-cash conversion factor.
